(19) United States
(12) Patent Application Publication
(10) Pub. No.: US 2017/0154059 A1
(43) Pub. Date: Jun. 1, 2017

(54) ENVIRONMENT QUALITY RECORDING SYSTEM AND METHOD, AND INDOOR ENVIRONMENT QUALITY RECORDING SYSTEM

(71) Applicants: Inventec (Pudong) Technology Corporation, Shanghai (CN); INVENTEC CORPORATION, TAIPEI CITY (TW)

(72) Inventor: Ying-Chih LU, TAIPEI CITY (TW)

(21) Appl. No.: 15/088,141

(22) Filed: Apr. 1, 2016

(30) Foreign Application Priority Data
Nov. 27, 2015 (CN) 201510851584.8
Nov. 30, 2015 (CN) 201510861966.9

(51) Int. Cl. G06F 17/30; H04L 29/08

(52) U.S. Cl. CPC G06F 17/30312; H04L 67/12

(57) ABSTRACT

An environment quality recording system includes a database, an analysis device, a recording platform and an electrical device. The database stores a platform environment quality datum and a device position datum. The recording platform generates and sends sensing data to the analysis device. The analysis device generates and stores the platform environment quality datum in the database. The electrical device is configured to send the device position datum to the analysis device. The analysis device generates real-time environment quality datum according to the device position datum, and determines if the environment quality data is valid according to a valid condition. When determining the real-time environment quality datum is valid, the analysis device sends the environment quality data to the electrical device.

### RELATED APPLICATIONS

This application claims priority to Chinese Application Serial Number 201510851584.8, filed Nov. 27, 2015, and Chinese Application Serial Number 201510861966.9, filed Nov. 30, 2015, which are herein incorporated by reference.

### BACKGROUND

Technical Field

The present invention relates to a recording technology. More particularly, the present invention relates to an environment quality recording system, an environment quality recording method, an indoor environment quality recording system and an indoor environment quality recording method.

Description of Related Art

As environment changes and industry develops, an environment where human lives may have different environment qualities according to different time or different locations. The environment in particular areas can even be harmful to a human body. In a technology regarding environment monitoring, the technology mostly pays attention to large area environment monitoring. Because the environment may change by time, a single user cannot precisely know whether there is harmful material at the current location or indoor location.

### SUMMARY

In order to record environment quality of a location at which a user is located, an aspect of the present disclosure provides an environment quality recording system, which includes a database, an analysis device, at least one recording platform and an electrical device. The database is configured to store at least one platform environment quality datum and a device position datum. The at least one recording platform is configured to generate and send a plurality of sensing data to the analysis device. The analysis device is configured to generate the at least one platform environment quality datum according to the sensing data and to store the at least one platform environment quality datum in the database. The electrical device is configured to send the device position datum to the analysis device. The analysis device is configured to store the device position datum in the database. The analysis device is configured to determine a real-time environment quality datum according to the device position datum from the at least one platform environment quality datum, and to determine whether the real-time environment quality datum is valid according to a valid condition. When the analysis device determines that the real-time environment quality datum is valid, the analysis device sends the real-time environment quality datum to the electrical device.

In an embodiment of the present disclosure, the electrical device is configured to send the device position datum to the analysis device through a user account. The analysis device generates a user path environment quality datum according to the user account, the device position datum and the valid real-time environment quality datum, and stores the user path environment quality datum in the database.

In an embodiment of the present disclosure, the analysis device is configured to generate a user path environment quality chart according to the user path environment quality datum, and to display a standard value on the user path environment quality chart.

In an embodiment of the present disclosure, each of the at least one recording platform comprises a plurality of sensors, a sensor network device and a control device. The sensors are configured to generate the sensing data and a platform position datum. The sensor network device is connected to the sensors. The control device is connected to the sensor network device and configured to receive the sensing data and the platform position datum through the sensor network device, and to periodically send the sensing data and the platform position datum to the analysis device. The at least one platform environment quality datum comprises the platform position datum.

In an embodiment of the present disclosure, the valid condition comprises a time range and a distance range.

Another aspect of the present application provides an environment quality recording method, which includes steps as follows At least one platform environment quality datum is generated according to a plurality of sensing data. A real-time environment quality datum is determined from the at least one platform environment quality datum according to a device position datum of an electrical device. A determination is made to determine whether the real-time environment quality datum is valid according to a valid condition. When the real-time environment quality datum is determined to be valid, the real-time environment quality datum is sent to the electrical device.

In an embodiment of the present disclosure, a user path environment quality datum is generated according to a user account, the device position datum and the valid real-time environment quality datum.

In an embodiment of the present disclosure, a user path environment quality chart is generated according to the user path environment quality datum. A standard value is displayed on the user path environment quality chart.

In an embodiment of the present disclosure, the sensing data and a platform position datum are generated by a plurality of sensors. The at least one platform environment quality datum comprises the platform position datum.

In an embodiment of the present disclosure, the valid condition comprises a time range and a distance range.

Another aspect of the present application provides an indoor environment quality recording system, which includes a database, an analysis device, at least one identifying unit, a recording platform and an electrical device. The database is configured to store at least one room environment quality datum and a device position datum. At least one identifying unit corresponds to at least one space. A recording platform is configured to generate and send a plurality of sensing data to the analysis device. The analysis device is configured to generate the at least one room environment quality datum according to the sensing data and to store the at least one room environment quality datum in the database. The electrical device is configured to read one of the at least one identifying unit to generate and send the device position datum to the analysis device. The analysis device is configured to store the device position datum in the database, to determine a real-time environment quality datum from the at least one room environment quality datum according to the device position datum, and to send the real-time environment quality datum to the electrical device.

In an embodiment of the present disclosure, the electrical device is configured to send the device position datum to the analysis device through a user account. The analysis device generates a user path environment quality datum according to the user account, the device position datum and the real-time environment quality datum, and stores the user path environment quality datum in the database.

In an embodiment of the present disclosure, the analysis device is configured to generate a user path environment quality chart according to the user path environment quality datum, and to display a standard value on the user path environment quality chart.

In an embodiment of the present disclosure, the recording platform comprises a plurality of sensors, a sensor network device and a control device. The sensors with a plurality of sensor identification codes corresponds to the at least one identifying unit. The sensors are configured to generate the sensing data. The database is configured to store a spatial arrangement datum. The spatial arrangement datum records the sensor identification codes and a corresponding relationship between the sensors and the at least one identifying unit. The sensor network device is connected to the sensors. The control device is connected to the sensor network device. The control device is configured to receive the sensing data through the sensor network device, and to periodically send the sensing data to the analysis device.

In an embodiment of the present disclosure, the electrical device reads one of the at least one identifying unit through a wireless communication technology.

Another aspect of the present application provides an indoor environment quality recording method, which includes steps as follows. At least one room environment quality datum is generated according to a plurality of sensing data. One of the at least one identifying unit is read to generate a device position datum by an electrical device. A real-time environment quality datum is determined from the at least one room environment quality datum according to the device position datum. The real-time environment quality datum is sent to the electrical device.

In an embodiment of the present disclosure, a user path environment quality datum is generated according to a user account, the device position datum and the real-time environment quality datum.

In an embodiment of the present disclosure, a user path environment quality chart is generated according to the user path environment quality datum. A standard value is displayed on the user path environment quality chart.

In an embodiment of the present disclosure, the sensing data is generated by a plurality of sensors. The sensors have a plurality of sensor identification code corresponding to the at least one identifying unit. A spatial arrangement datum records the sensor identification codes and a corresponding relationship between the sensors and the at least one identifying unit.

In an embodiment of the present disclosure, the electrical device reads one of the at least one identifying unit through a wireless communication technology.

In conclusion, the present disclosure uses a user's electrical device to send a device position datum to acquire a real-time environment quality datum around the user. Moreover, the present disclosure determines validity of the real-time environment quality datum according to a valid condition, determines user's indoor position precisely through the identifying unit, and records all environment quality data and indoor environment quality data of paths that have been walked through by the user. Therefore, the user can precisely know environment quality and indoor environment quality of paths that have been walked through by the user.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of an environment quality recording system according to an embodiment of the present disclosure;

FIG. 2 is a schematic diagram of a recording platform of an environment quality recording system according to an embodiment of the present disclosure;

FIG. 3 is a schematic diagram of a usage situation of an environment quality recording system according to an embodiment of the present disclosure;

FIG. 4 is a schematic diagram of an illustrative user path environment quality chart according to an embodiment of the present disclosure;

FIG. 5 is a flow chart of an environment quality recording method according to an embodiment of the present disclosure;

FIG. 6 is a schematic diagram of an indoor environment quality recording system according to an embodiment of the present disclosure;

FIG. 7 is a schematic diagram of an indoor environment quality recording system according to an embodiment of the present disclosure; and

FIG. 8 is a flow chart of an indoor environment quality recording method according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure. Moreover, the description of steps is not used to limit the execution sequence thereof. Any device with an equivalent effect through rearrangement is also covered by the present disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

In this document, the term “coupled” may also be termed as “electrically coupled,” and the term “connected” may be termed as “electrically connected.” “Coupled” and “connected” may also be used to indicate that two or more elements cooperate or interact with each other.

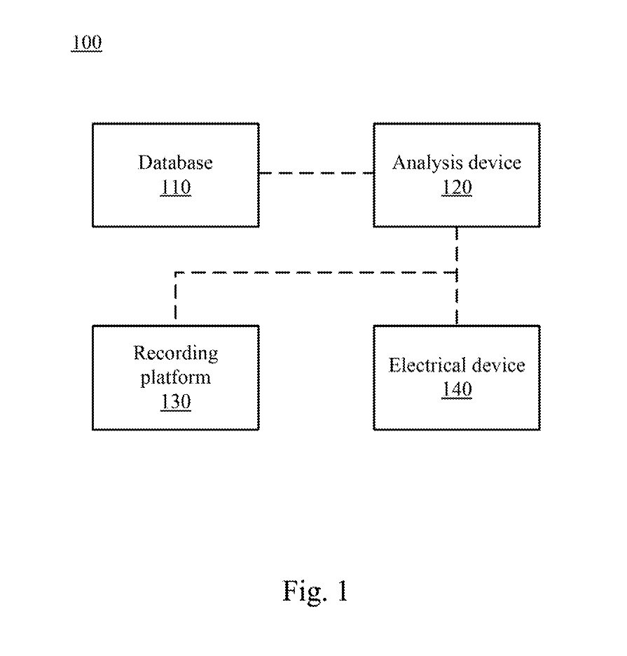

Reference is first made to FIG. 1. FIG. 1 is a schematic diagram of an environment quality recording system 100 according to an embodiment of the present disclosure. The environment quality recording system 100 includes a database 110, an analysis device 120, at least one recording platform 130 and an electrical device 140. The database 110 stores at least one platform environment quality datum, a device position datum and a user path environment quality datum. For example, the electrical device 140 can be a mobile electrical device, which includes a cell phone, a tablet computer, a notebook, and so on, However, the present disclosure is not limited to this example.

When the user wants to know environment quality data of a current location, the user can send a device position datum to the analysis device 120 by using the electrical device 140. Next, the analysis device is configured to determine a real-time environment quality datum from the at least one platform environment quality datum in the database 110 according to the device position datum, and to determine whether the real-time environment quality datum is valid according to a valid condition. When the analysis device 120 determines that the real-time environment quality datum is valid, the analysis device 120 sends the real-time environment quality datum to the electrical device 140. Therefore, the user can know quality of the current located environment through the real-time environment quality datum displayed on the electrical device 140.

In one embodiment, the user uses the electrical device 140 to log in a user account, and sends a time stamp, the device position datum, an identification code of the electrical device 140, and an identification code of the user account to the analysis device 120. When the user uses the electrical device 140 to send device position data at different locations to the analysis device 120, the analysis device 120 can record each of the device position data in the database 110, and integrates position data of the same identification code of the electrical device 140 into the same device position datum.

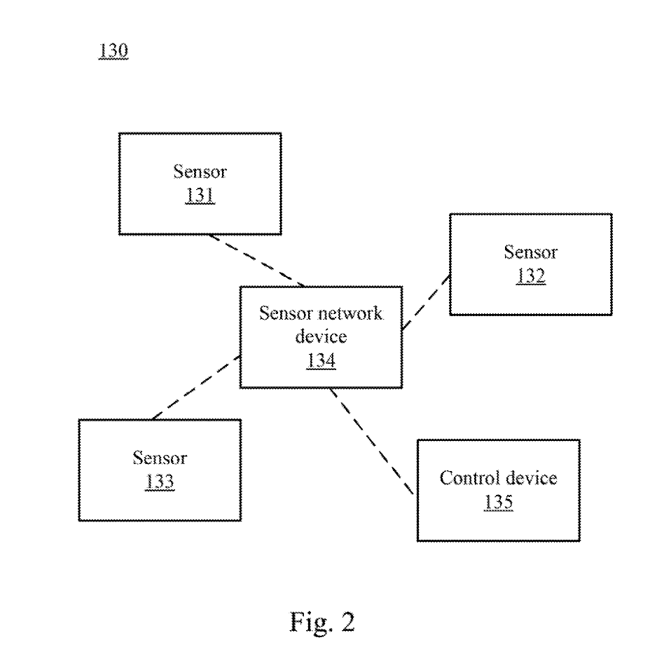

In order to describe the platform environment quality datum, reference is made to FIG. 2. FIG. 2 is a schematic diagram of a recording platform 130 of an environment quality recording system 100 according to an embodiment of the present disclosure. The recording platform 130 includes sensors 131-133, a sensor network device 134 and a control device 135. The sensors 131-133 include a positioning sensor (e.g., a global positioning system (GPS) sensor), and are configured to generate a plurality of sensing data and a platform position datum of environment around the recording platform 130. The sensor network device 134 is configured to be connected to the sensors 131-133. For example, the sensor network device 134 can be a wireless transmission device which communicates with the sensors 131-133 and the control device 135 through a wireless transmission protocol (e.g., Zigbee, Bluetooth). The control device 135 is connected to the sensor network device 134. The control device 135 is configured to receive the sensing data and the platform position datum through the sensor network device 134, and to send the sensing data and the platform position datum to the analysis device 120. The analysis device 120 is configured to generate the at least one platform environment quality datum according to the sensing data and to stare the at least one platform environment quality datum in the database 110. The aforementioned platform environment quality datum includes the platform position datum. In one embodiment, data which are sent by the control device 135 to the analysis device 120 include an identification code of recording platform, a time stamp, a platform position datum, identification codes of the sensors 131-133, types of the sensors 131-133, the sensing data, units of the sensing data, information that indicates indoor or outdoor. However, the present disclosure is not limited to this example. The analysis device 120 is further configured to generate the platform environment quality datum corresponding to the recording platform 130 according to the aforementioned data sent by the control device 135, and to store the platform environment quality datum in a table form in the database 110.

The aforementioned sensors 131-133 include an air quality sensor, a temperature and humidity sensor, a serial GPS satellite receiving module, a human body sensor, a flame sensor, a condensation sensor, and an ultraviolet sensor. However, the present disclosure is not limited to this example. The air quality sensor can be configured to detect concentrations of bacteria, fungus, carbon monoxide (CO), carbon dioxide (CO₂), formaldehyde (HCHO), nitrogen dioxide (NO₂), carbon dioxide (SO₂), ozone (O₃), suspended particulate matter with a diameter smaller than 10 microns(μm) (PM10), suspended particulate matter with a diameter smaller than 2.5 microns (μm) (PM2p5), total suspended particulate (TSP) matter with a diameter smaller than 100 microns, total volatile organic compounds (TVOC) and lead (Pb) in the air.

In one embodiment, communication between the sensors 131-133 and the sensor network device 134 is realized through a Zigbee protocol, and communication between the sensor network device 134 and the control device 135 is realized through a Bluetooth protocol. The control device 135 includes a network interface controller (NIC), which is configured to send the sensing data to the analysis device 120 through Internet.

In one embodiment, the electrical device 140 carried by the user also includes a sensor to detect environment quality. After the user uses the electrical device 140 to log in the user account, the user can send a device position datum, an identification code of the electrical device, an identification code of the user account and the sensing data generated by the sensor to the analysis device 120. In other words, the electrical device 140 including the sensor is similar to a movable recording platform.

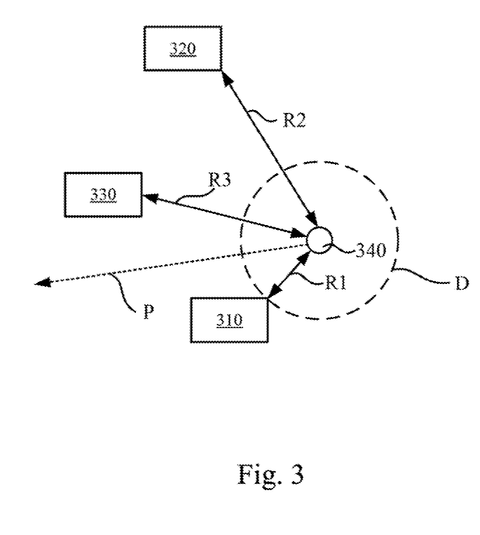

In order to describe the aforementioned valid condition, reference is made to FIG. 3. FIG. 3 is a schematic diagram of a usage situation of an environment quality recording system according to an embodiment of the present disclosure. As shown in FIG. 3, an environment quality recording system 100 of the present disclosure can include recording platforms 310-330 located on different locations to record environment quality on the different locations, and to periodically (e.g., every 3 minutes) send the sensing data to the analysis device 120. The analysis device 120 can respectively store corresponding platform environment quality data according to different recording platforms 310-330 (e.g., through identification codes of the recording platforms 310-330) in the database. When the user moves along a path P in an environment, the user can log in the user account through the electrical device 340, and send a device position datum to the analysis device 120 at time T1. As mentioned above, the recording platforms 310-330 periodically send the platform position data to the analysis device 120. The analysis device 120 can calculate distances R1-R3 between the electrical device 140 and the adjacent recording platforms 310-330 according to the device position datum and the platform position data. Because the analysis device 120 first determines that the recording platform 310 is nearest to the electrical device 340 (for example, the analysis device 120 determines that the distance R1 is the minimum one of the distances R1-R3), and then the analysis device 120 further determines whether the distance R1 is in a distance range D of a valid condition. In this embodiment, the distance R1 is in the distance range D, so that the analysis device 120 determines that the real-time environment quality datum corresponding to the recording platform 310 from the platform environment quality data is sent to the electrical device 140. Therefore, the user can know quality of the adjacent environment through the real-time environment quality datum.

In one embodiment, the analysis device 120 further determines whether time differences between the time T1 and time of every platform environment quality datum are in a time range T of the valid condition. For example, the recording platform 310 that is nearest to the user at the end sends the platform environment quality datum to the analysis device 120 at time T2. The analysis device 120 determines whether a time difference ΔT between the time T1 and the time T2 is in the time range T to determine whether the real-time environment quality datum is valid. If the time difference AT is out of the time range T, it indicates that the real-time environment quality datum can hardly represent the current environment quality. Therefore, the analysis device 120 determines that the real-time environment quality datum is invalid, and does not send the real-time environment quality datum to the electrical device 140. In contrast, if the time difference ΔT is in the time range T, then the analysis device 120 sends the real-time environment quality datum to the electrical device 140.

Therefore, the user can precisely know quality of the adjacent environment through the real-time environment quality datum.

Moreover, the analysis device 120 generates a user path environment quality datum according to the user account, the device position datum and the real-time environment quality datum that is determined to be valid, and stores the user path environment quality datum in the database 110. For example, the analysis device 120 selects the valid real-time environment quality data corresponding to the position data from the database 110 according to the position data that are sent with the same user account by using same or different electrical devices 140 at different time points, to generate the user path environment quality datum. In other words, the user path environment quality datum shows moving paths of the user that logs in the same user account and environment quality data of the moving paths. As a result, the user can know environment quality data in a particular time period or on all paths P that have been walked through by using the user account. Moreover, the user can also selectively show particular environment quality data of the user path environment quality datum through the electrical device 140. For example, the electrical device 140 only displays concentration of carbon dioxide.

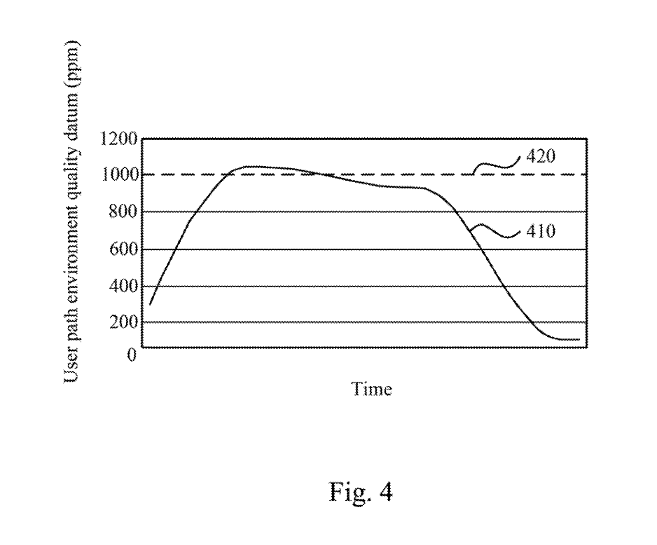

In one embodiment, the analysis device 120 is configured to generate a user path environment quality chart (as shown as a curve 410 in FIG. 4) according to the user path environment quality datum, and to display a standard value 420 (e.g., national standard value) on the user path environment quality chart. The analysis device 120 can process the user path environment quality datum with appropriate calculation, so as to be compared with the standard value. For example, the analysis device 120 can calculate a mean of the user path environment quality datum in 8 hours, so as to be compared with a standard value of 1000 parts per million (ppm). The analysis device 120 can also send the user path environment quality chart to the electrical device 140. Therefore, the user can understand the history of environment quality easily.

In practice, the database 110 can be stored in a storage device, such as a hard disk, any non-transitory computer readable storage medium, or a database accessible from network. Those of ordinary skill in the art can think of the appropriate implementation of the database 110 without departing from the spirit and scope of the present disclosure. The analysis device 120 can be implemented as a computer system (e.g., a server system), which includes an application programming interface (API) (e.g., representational state transfer (REST) application programming interface) and a web server. Specifically, the application programming interface is configured to log in or log out the analysis device 120 through a user account, to send the device position datum and the platform environment quality datum, and to acquire the user path environment quality datum, but the present disclosure is not limited to this example.

In one embodiment, data are transmitted between the analysis device 120 and the recording platform 130 through Internet, and between the analysis device 120 and the electrical device 140.

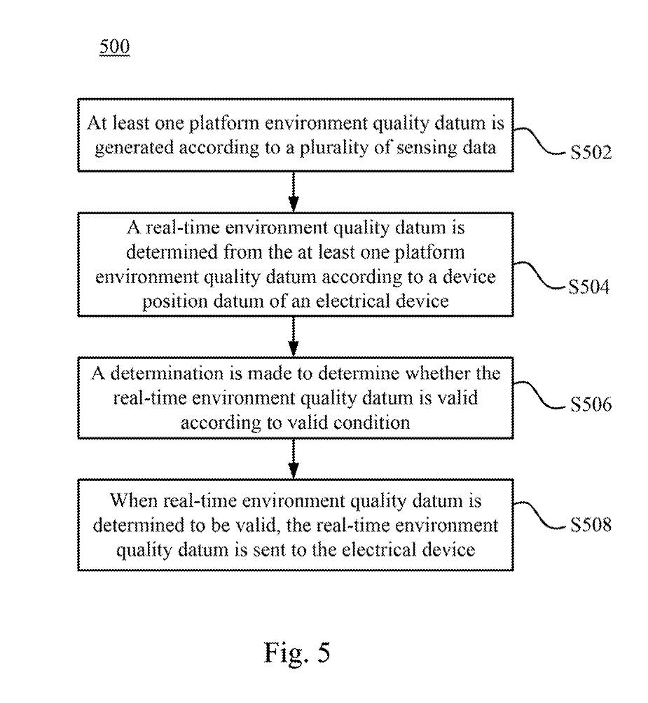

FIG. 5 is a flow chart of an environment quality recording method 500 according to an embodiment of the present disclosure. The environment quality recording method 500 includes a plurality of steps S502-S508 and can be implemented by the environment quality recording system 100 as shown in FIG. 1. However, those skilled in the art should understand that, unless a particular sequence is specified, the sequence of the steps in the present embodiment can be adjusted according to actual needs. Moreover, all or some of the steps can even be executed simultaneously. Specific implementation is disclosed as above, and would not be repeated herein.

In step S502, at least one platform environment quality datum is generated according to a plurality of sensing data.

In step S504, a real-time environment quality datum is determined from the at least one platform environment quality datum according to a device position datum of an electrical device.

In step S506, a determination is made to determine whether the real-time environment quality datum is valid according to valid condition.

In step S508, when real-time environment quality datum is determined to be valid, the real-time environment quality datum is sent to the electrical device.

Through the above embodiments, the present disclosure can uses a user's electrical device to send a device position datum to acquire a real-time environment quality datum around the user. Moreover, the present disclosure determines validity if the real-time environment quality datum according to a valid condition, and records all environment quality data of paths that have been walked through by the user. Therefore, the user can precisely know the environment quality of the paths that have been walked through.

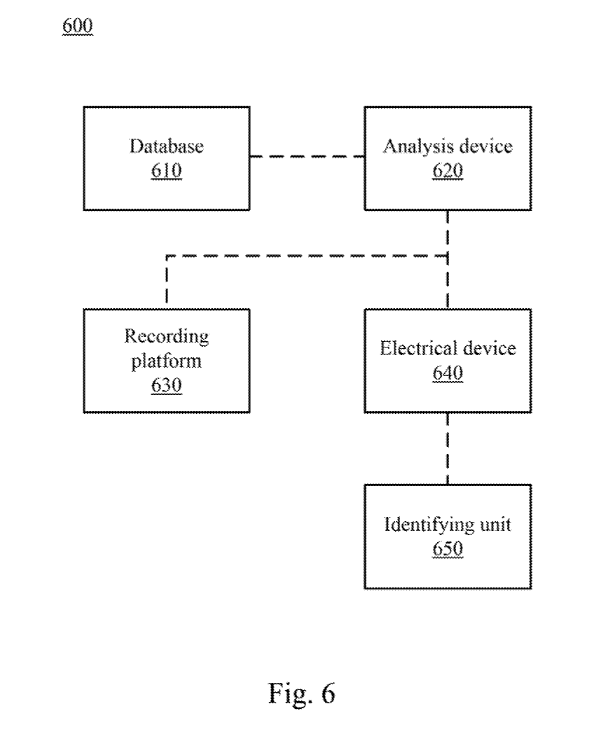

Reference is made to FIG. 6. FIG. 6 is a schematic diagram of an indoor environment quality recording system 600 according to an embodiment of the present disclosure. The indoor environment quality recording system 600 includes a database 610, an analysis device 620, a record recording platform 630, an electrical device 640 and at least one identifying unit 650. The database 610 stores at least one room environment quality datum, a device position datum and a user path environment quality datum. For example, the electrical device 640 be a mobile electrical device, which includes a cell phone, a tablet computer, a notebook, and so on. However, the present disclosure is not limited to this example.

In one embodiment, the indoor environment quality recording system 600 includes a number of identifying units 650, which are disposed in different indoor spaces (e.g., entrances of rooms) to identify the different indoor spaces

When the user wants to know indoor environment quality data of a current location, the user can read one of the at least one identifying unit (e.g., a identifying unit that is nearest to the user) to generate a device position datum, and send the device position datum to the analysis device 620 by using the electrical device 640. Next, the analysis device is configured to determine a real-time environment quality datum from the at least one platform environment quality datum in the database 610 according to the device position datum, and send the real-time environment quality datum to the electrical device 640. Therefore, the user can know quality of the current located indoor environment through the real-time environment quality datum displayed on the electrical device 640.

In one embodiment, the user operates the electrical device 640 to read data of the identifying unit (e.g., radio frequency identification (RFID) tag) through wireless communication technology (e.g., radio frequency identification (RFID)). In the present embodiment, the electrical device 640 includes a wireless reader, such as a near field communication (NFC) reader, a RFID reader. Because error of global positioning system (GPS) technology for indoor positioning, the present disclosure uses the identifying unit disposed in different spaces to identify a position of the user precisely.

In one embodiment, the user uses the electrical device 640 to log in a user account, and sends a time stamp, the device position datum, an identification code of the electrical device 640, an identification code of the user account to the analysis device 620. When the user uses the electrical device 640 sending device position data at different locations to the analysis device 620, the analysis device 620 can record each of the device position data in the database 610, and integrates position data of the same identification code of the electrical device 140 into the same device position datum.

In order to describe the room environment quality datum, reference is made to FIG. 2. In one embodiment, a recording platform of an indoor environment quality recording system is similar to the recording platform 130 of the environment quality recording system 100 shown in FIG. 2. One or more record recording platforms 630 can be disposed in a single building. For example, different record recording platforms 630 can be disposed in different floors or particular areas (e.g., company or home). The recording platform 130 includes sensors 131-133, a sensor network device 134 and a control device 135. The sensors 131-133 include a positioning sensor (e.g., a global positioning system (GPS) sensor), and are configured to generate a plurality of sensing data and a platform position datum of environment around the recording platform 130. The sensor network device 134 is configured to connect to the sensors 131-133. For example, the sensor network device 134 can be a wireless transmission device which communicates with the sensors 131-133 and the control device 135 through a wireless transmission protocol (e.g., Zigbee, Bluetooth). The control device 135 is connected to the sensor network device 134. The control device 135 is configured to receive the sensing data and the platform position datum through the sensor network device 134, and send the sensing data and the platform position datum to the analysis device 620. The analysis device 620 is configured to generate the at least one room environment quality datum according to the sensing data and store the at least one room environment quality datum in the database 610. The aforementioned room environment quality datum includes the platform position datum. In one embodiment, data that is sent to the analysis device 620 by the control device 135 includes an identification code of recording platform, a time stamp, a platform position datum, identification codes of the sensors 131-133, types of the sensors 131-133, the sensing data, units of the sensing data, information that indicates indoor or outdoor. However, the present disclosure is not limited to this example. The analysis device 620 is further configured to generate the room environment quality datum corresponding to the identifying unit 650 (i.e., different spaces) according to the aforementioned data sent by the control device 135, and to store the room environment quality datum in table form in the database 610.

The aforementioned sensors 131-133 include an air quality sensor, a temperature and humidity sensor, a serial GPS satellite receiving module, a human body sensor, a flame sensor, a condensation sensor, and an ultraviolet sensor. However, the present disclosure is not limited to this example. The air quality sensor can be configured to detect concentrations of bacteria, fungus, carbon monoxide (CO), carbon dioxide (CO₂), formaldehyde (HCHO), nitrogen dioxide (NO₂), carbon dioxide (SO₂), ozone (Oₛ), suspended particulate with a diameter lower than 10 microns m) (PM10), suspended particulate with a diameter lower than 2.5 microns (μm) (PM2p5), total suspended particulate (TSP) with a diameter lower than 100 microns, total volatile organic compounds (TVOC) and lead (Pb) in the air.

In one embodiment, communication between the sensors 131-133 and the sensor network device 134 is realized through a Zigbee protocol, and communication between the sensor network device 134 and the control device 135 is realized through a Bluetooth protocol. The control device 135 includes a network interface controller (NIC), which is configured to send the sensing data to the analysis device 620 through Internet

In one embodiment, the electrical device 640 carried by the user also includes a sensor to detect environment quality. After the user uses the electrical device 640 to log in the user account, the user can send a device position datum, an identification code of the electrical device, an identification code of the user account and the sensing data generated by the sensor to the analysis device 620. In other words, the electrical device 640 including the sensor is similar to a movable recording platform.

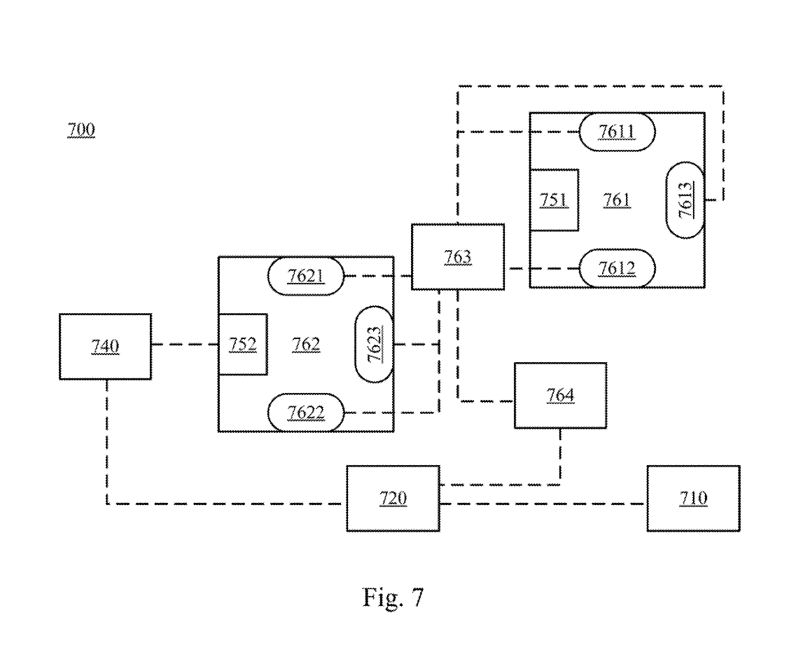

Reference is made to FIG. 7. FIG. 7 is a schematic diagram of an indoor environment quality recording system 700 according to an embodiment of the present disclosure. As shown in FIG. 7 record recording platforms of the indoor environment quality recording system 700 of the present disclosure can include sensors 7611-7613 and 7621-7623 disposed in different spaces 761 and 762 to record environment quality of the different spaces 761 and 762. The control device 764 receives sensing data of the sensors 7611-7613 and 7621-7623 through the sensor network device 763, and periodically (e.g., every 3 minutes) sends the sensing data to an analysis device 720. The sensors 7611-7613 in the pace 761 corresponds to the identifying unit 751, and the sensors 7621-7623 in the space 762 corresponds to the identifying unit 752. A corresponding relationship is recorded in a spatial arrangement datum in the database 710. The analysis device 720 can respectively store the corresponding room environment quality datum in the database 310 according to the different spaces 761 and 762 (e.g., through the identifying units 751 and 752).

When a user approached the identifying unit 752 of the space 762, the user can operate the electrical device 740 to log in a user account and read the identifying unit 752 to generate a device position datum. The aforementioned device position datum indicates that a position of the electrical device 640 is close to the space 762. Next, the user can operate the electrical device 740 to send the device position datum to the analysis device 720. The analysis device 720 is configured to determine a real-time environment quality datum from the room environment quality datum according to the device position datum, and send the real-time environment quality datum to the electrical device 740. Specifically, the analysis device 720 acquires the room environment quality datum of the sensors 7621-7623 in the space 762 according to the device position datum as the real-time environment quality datum, and sends the real-time environment quality datum to the electrical device 740. The sensors 7621-7623 correspond to the identifying unit 752 corresponding to the space 762.

Similarly, when the user approaches the identifying unit 751 of the space 761, the user can operate the electrical device 740 to log in a user account and read the identifying unit 751 to generate a device position datum. The analysis device 720 acquires room environment quality datum of the sensors 7611-7613 in the space 761 as the real-time environment quality datum, and sends the real-time environment quality datum to the electrical device 740. The sensors 7611-7613 correspond to the identifying unit 751 in the space 761.

Therefore, the user can precisely know quality of the current located indoor environment through the real-time environment quality datum.

Moreover, the analysis device 720 generates a user path environment quality datum according to the user account, the device position datum and the real-time environment quality datum, and stores the user path environment quality datum in the database 710. As a result, the user can know environment quality data in a particular time period or all spaces walked through by using the user account. Moreover, the user can also selectively show particular environment quality data of the user path environment quality datum through the electrical device 740. For example, the electrical device 640 only displays concentration of carbon dioxide.

In one embodiment, the analysis device 620 is configured to generate a user path environment quality chart (as shown as a curve 410 in FIG. 4) according to the user path environment quality datum, and display a standard value 420 (e.g., national standard value) on the user path environment quality chart. The analysis device 620 can process the user path environment quality datum with appropriate calculation to compare with the standard value. For example, the analysis device 620 can calculate a mean of the user path environment quality datum in 8 hours to compare with a standard value of 1000 parts per million (ppm). The analysis device 620 can also send the user path environment quality chart to the electrical device 640. Therefore, the user can understand history of environment quality easily.

In practice, the database 610 can be stored in a storage device, such as a hard disk, any non-transitory computer readable storage medium, or a database accessible from network. Those of ordinary skill in the art can think of the appropriate implementation of the database 610 without departing from the spirit and scope of the present disclosure. The analysis device 620 can be implemented as a computer system (e.g., a server system), which includes an application programming interface (API) (e.g., representational state transfer (REST) application programming interface) and a web server. Specifically, the application programming interface is configured to log in or log out the analysis device 620 through a user account, send the device position datum, send the platform environment quality datum, and acquire the user path environment quality datum, but the present disclosure is not limited to this example.

In one embodiment, data are transmitted through Internet between the analysis device 620 and the recording platform 630, and between the analysis device 620 and the electrical device 640.

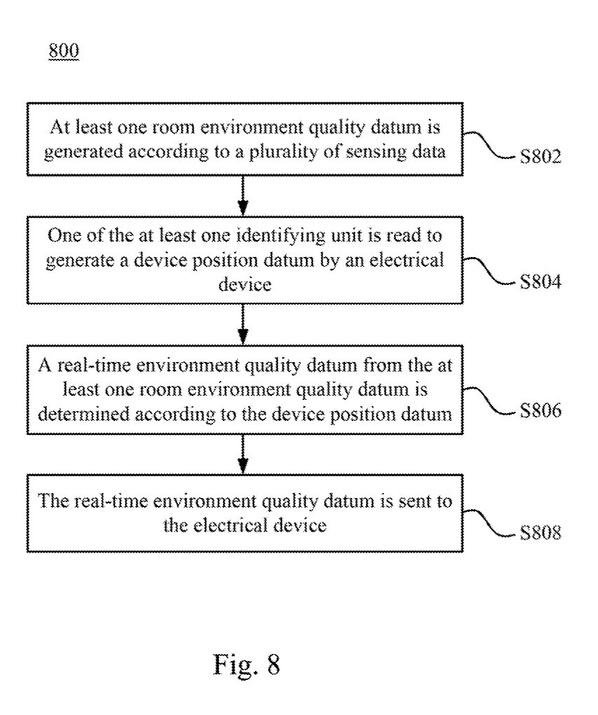

FIG. 8 is a flow chart of an indoor environment quality recording method 800 according to an embodiment of the present disclosure. The environment quality recording method 800 includes a plurality of steps S802-S808 and can be implemented by the environment quality recording systems 600 and 700 as shown in FIGS. 6 and 7. However, those skilled in the art should understand that, unless a particular sequence is specified, the sequence of the steps in the present embodiment can be adjusted according to actual needs. Moreover, all or some of the steps can even be executed simultaneously. Specific implementation is disclosed as above, and would not be repeated herein.

In step S802, at least one room environment quality datum is generated according to a plurality of sensing data.

In step S804, one of the at least one identifying unit is read to generate a device position datum by an electrical device.

In step S806, a real-time environment quality datum from the at least one room environment quality datum is determined according to the device position datum.

In step S808, the real-time environment quality datum is sent to the electrical device.

Through the above embodiments, the present disclosure can uses a user's electrical device to send a device position datum to acquire a real-time environment quality datum around the user. Moreover, the present disclosure determines validity of the real-time environment quality datum according to a valid condition, determines user's indoor position precisely through the identifying unit, and records all environment quality data and indoor environment quality data of paths that have been walked through by the user. Therefore, the user can precisely know environment quality and indoor environment quality of paths that have been walked through by the user.

Even though the present disclosure is disclosed as above, the disclosure is not used to limit the present disclosure. It will be apparent to those skilled in the art that various modifications and variations can be made to the present disclosure without departing from the spirit or scope of the invention; thus, it is intended that the range protected by the present disclosure should refer to the scope of the following claims.

What is claimed is:

1. An environment quality recording system, comprising:
a database, configured to store at least one platform environment quality datum and a device position datum;
an analysis device;
at least one recording platform, configured to generate and send a plurality of sensing data to the analysis device, wherein the analysis device is configured to generate the at least one platform environment quality datum according to the sensing data and to store the at least one platform environment quality datum in the database; and
an electrical device configured to send the device position datum to the analysis device, wherein the analysis device is configured to store the device position datum in the database;
wherein the analysis device is configured to determine a real-time environment quality datum according to the device position datum from the at least one platform environment quality datum, and to determine whether the real-time environment quality datum is valid according to a valid condition, and when the analysis device determines that the real-time environment quality datum is valid, the analysis device sends the real-time environment quality datum to the electrical device.

2. The environment quality recording system of claim 1, wherein the electrical device is configured to send the device position datum to the analysis device through a user account, and the analysis device generates a user path environment quality datum according to the user account, the device position datum and the valid real-time environment quality datum, and stores the user path environment quality datum in the database.

3. The environment quality recording system of claim 2, wherein the analysis device is configured to generate a user path environment quality chart according to the user path environment quality datum, and to display a standard value on the user path environment quality chart.

4. The environment quality recording system of claim 1, wherein each of the at least one recording platform comprises:
a plurality of sensors, configured to generate the sensing data and a platform position datum;
a sensor network device, connected to the sensors; and
a control device, connected to the sensor network device and configured to receive the sensing data and the platform position datum through the sensor network device, and to periodically send the sensing data and the platform position datum to the analysis device, wherein the at least one platform environment quality datum comprises the platform position datum.

5. The environment quality recording system of claim 1, wherein the valid condition comprises a time range and a distance range.

6. An environment quality recording method, comprising:
generating at least one platform environment quality datum according to a plurality of sensing data;
determining a real-time environment quality datum from the at least one platform environment quality datum according to a device position datum of an electrical device;
determine whether the real-time environment quality datum is valid according to a valid condition; and
sending the real-time environment quality datum to the electrical device when the real-time environment quality datum is determined to be valid.

7. The environment quality recording method of claim 6, further comprising:
generating a user path environment quality datum according to a user account, the device position datum and the valid real-time environment quality datum.

8. The environment quality recording method of claim 7, further comprising:
generating a user path environment quality chart according to the user path environment quality datum; and
displaying a standard value on the user path environment quality chart.

9. The environment quality recording method of claim 6, further comprising:
generating the sensing data and a platform position datum by a plurality of sensors, wherein the at least one platform environment quality datum comprises the platform position datum.

10. The environment quality recording method of claim 6, wherein the valid condition comprises a time range and a distance range.

11. An indoor environment quality recording system, comprising:
a database configured to store at least one room environment quality datum and a device position datum;
an analysis device;
at least one identifying unit corresponding to at least one space;
a recording platform configured to generate and send a plurality of sensing data, wherein the analysis device is configured to generate the at least one room environment quality datum according to the sensing data and to store the at least one room environment quality datum in the database; and
an electrical device configured to read one of the at least one identifying unit to generate and send the device position datum to the analysis device, wherein the analysis device is configured to store the device position datum in the database, to determine a real-time environment quality datum from the at least one room environment quality datum according to the device position datum, and to send the real-time environment quality datum to the electrical device.

12. The indoor environment quality recording system of claim 11, wherein the electrical device is configured to send the device position datum to the analysis device through a user account, and the analysis device generates a user path environment quality datum according to the user account, the device position datum and the real-time environment quality datum, and stores the user path environment quality datum in the database.

13. The indoor environment quality recording system of claim 12, wherein the analysis device is configured to generate a user path environment quality chart according to the user path environment quality datum, and to display a standard value on the user path environment quality chart.

14. The indoor environment quality recording system of claim 11, wherein the recording platform comprises:
a plurality of sensors with a plurality of sensor identification codes corresponding to the at least one identifying unit, wherein the sensors are configured to generate the sensing data, and the database is configured to store a spatial arrangement datum, and the spatial arrangement datum records the sensor identification codes and a corresponding relationship between the sensors and the at least one identifying unit;
a sensor network device connected to the sensors; and
a control device connected to the sensor network device, wherein the control device is configured to receive the sensing data through the sensor network device, and to periodically send the sensing data to the analysis device.

15. The indoor environment quality recording system of claim 11, wherein the electrical device reads one of the at least one identifying unit through a wireless communication technology.
